(19) United States
(12) Patent Application Publication
(10) Pub. No.: US 2023/0026058 A1
(43) Pub. Date: Jan. 26, 2023

(54) LONGITUDINAL ADJUSTING DEVICE FOR A VEHICLE SEAT

(71) Applicant: Fisher Dynamics Germany GmbH., Wuppertal (DE)

(72) Inventors: Burckhard Becker, Solingen (DE); Axel Speck, Pinneberg (DE)

(21) Appl. No.: 17/957,513

(22) Filed: Sep. 30, 2022

Related U.S. Application Data
(63) Continuation of application No. PCT/EP2021/057966, filed on Mar. 26, 2021.

(30) Foreign Application Priority Data
Mar. 31, 2020 (DE) 10 2020 108 920.1

(51) Int. Cl. B60N 2/07; B60N 2/06

(52) U.S. Cl. CPC B60N 2/07; B60N 2/067

(57) ABSTRACT

A longitudinal adjusting device for a vehicle seat with a floor rail for fastening to a vehicle floor, the floor rail having a base wall for resting on the vehicle floor, with a seat rail that is displaceable with respect to the floor rail, with a spindle that is rigidly coupled to the floor rail, with a gear, which has a spindle nut, which is in engagement with the spindle, and is axially rigidly coupled to the seat rail, and with fastening means, which are guided through fastening openings on a fastening wall of the seat rail for fastening the gear on the seat rail. The longitudinal adjusting device may have a fastening wall arranged at an angle to the base wall and the fastening means for enclosing the gear reach through the complete seat rail and also absorb the crash forces with dual shear.

### CROSS-REFERENCE TO RELATED APPLICATIONS

This application is a continuation under 35 U.S.C. § 120 of co-pending International Patent Application no. PCT/EP2021/057966 filed Mar. 26, 2021, and benefit under 35 U.S.C. § 119(a)-(d) to German Patent Application no. 10 2020 108 920.1 filed Mar. 31, 2020, which are hereby incorporated by reference in its entirety as part of the present disclosure.

### FIELD OF THE INVENTION

The present invention relates to a longitudinal adjusting device for a vehicle seat.

### BACKGROUND

Longitudinal adjusting devices are used to move a vehicle seat along a longitudinal direction of the vehicle. In addition to such devices that are manually adjustable, longitudinal adjusting devices that are adjusted in a motor-driven manner are known. On the one hand, it is important for such longitudinal adjusting devices that they can also withstand large loads such as for example in the case of a crash so that the vehicle seat does not detach from its locking device in such a case.

DE 10 2006 011 717 B4 shows a longitudinal adjusting device, in which a floor rail is connected to the vehicle floor and a seat rail is connected to the vehicle seat. A motor-driven longitudinal adjustment takes place by means of a shaft, which drives a spindle nut by means of a worm, which together with a spindle forms a spindle-nut gear. The worm and the spindle nut are arranged in a gear housing, which is fastened by means of pins on an upper wall of the seat rail. The spindle is in turn rigidly connected to the floor rail.

However, in this longitudinal adjusting device, the fastening of the gear housing on the seat rail is not as strong as it could be. Should the fastening of the gear housing be detached from the seat rail, then the vehicle seat would no longer be fastened to the vehicle. However, even if no complete tearing off of the gear housing from the seat rail should occur in the event of a crash, such substantial damage to the fastening is nevertheless likely, that operation as intended is no longer possible.

FR 2 928 880 A1 describes a chassis that has slide rails, which comprise a movable profile and a fixed profile, which are mounted in a displaceable manner relative to one another along a longitudinal direction. An adjustment mechanism has a screw, which is mounted in a rotatable manner on a housing. A cross member extends between the sliders along a transverse direction perpendicular to the longitudinal direction. A motor is supported by the cross member and transmission chains drive the worm in a rotating manner. The crossbeam is fastened directly to the housing.

US 2017/0166090 A1 discloses an adjusting device for adjusting a longitudinal position of a vehicle seat, which comprises: a first guide rail; a spindle, which is fastened to the first guide rail and extends along a longitudinal axis; a second guide rail, which is movable in a linear manner along the longitudinal axis in relation to the first guide rail, wherein the second guide rail has a base and a first worm, which extends from the base; and a gear, which is fastened to the second guide rail and has a housing, wherein the gear is in operative connection with the spindle, in order to move the second guide rail relatively to the first guide rail. At least one support element is arranged on the second guide rail, wherein the at least one support element has a support surface running transversely to the longitudinal axis and facing the housing of the gear for supporting the gear with respect to the second guide rail. The support surface comprises a first edge, which faces the base or the first leg and has a welded section, by means of which the first edge is fastened to the base or the first leg by means of welding, wherein a tab protrudes from the first edge and the base or the first leg engages into an opening thereof.

EP 2 305 512 A2 discloses a lower rail or an upper rail. This has a first wall, which is arranged at a position in the width direction on a first of two opposite sides, and a second wall, which is arranged at a position in the width direction on the respective other side and opposite the first wall. At least one of the first wall and the second wall has an opening. At least one outer section of the holding element in the width direction and an outer section of the nut element in the width direction is inserted into the opening and arranged opposite an inner side surface of the opening.

### SUMMARY

An advantage of the invention includes improving longitudinal adjusting devices, e.g., with regards to its deformation with respect to the loads occurring in a crash.

An angled arrangement, with respect to the vehicle floor, of the openings of the seat rail for fastening the gear housing makes it possible to better absorb crash loads for various reasons. Specifically, already due to a slight enlargement of the extent of the longitudinal adjusting device, it becomes possible to design the fastening means, e.g., fasteners that are currently known of later become known, guided through the openings more robustly or equally also to guide the fastening means/fasteners through on the opposite side.

The proposed longitudinal adjusting device can be for a vehicle seat. The such proposed longitudinal adjusting device can have a floor rail for fastening to a vehicle floor, wherein the floor rail has a base wall for resting on the vehicle floor. In other words, the base wall rests on the vehicle floor in the case of the intended arrangement of the longitudinal adjusting device in the vehicle.

The proposed longitudinal adjusting device further may have a seat rail that is displaceable with respect to the floor rail, a spindle that is rigidly coupled to the floor rail, and a gear, which gear has a spindle nut, which is in engagement with the spindle, and is axially rigidly coupled to the seat rail. Axially rigidly coupled means that the gear is rigidly coupled to the seat rail with respect to a movement along a longitudinal axis of the spindle.

Likewise, the proposed longitudinal adjusting device can have fasteners or other fastening means, which fasteners/fastening means are guided through fastening openings on a fastening wall of the seat rail for fastening the gear on the seat rail.

In at least some embodiments, the fastening wall is arranged at an angle to the base wall. In other words, the fastening wall does not run parallel to the base wall. As the base wall should rest on the vehicle floor, the fastening wall does not run parallel to the vehicle floor in particular. Furthermore, the fastening wall may be in engagement with the floor rail. This engagement does not conflict with the displaceability of the seat rail with respect to the floor rail.

In principle, the floor rail can be fastened in any desired manner and either directly or indirectly to the vehicle floor. The base wall may have openings for fastening the floor rail to the vehicle floor. In particular, the longitudinal adjusting device can have floor fastening means, which are guided through the openings, for fastening the floor rail to the vehicle floor.

In at least some embodiments, the seat rail has a side wall arranged substantially parallel to the fastening wall. he side wall may be in engagement with the floor rail. Specifically, the seat rail may be guided with respect to the floor rail for the displaceability by means of the respective engagement of the fastening wall and the side wall with the floor rail. The side wall may be arranged opposite the fastening wall.

In at least some embodiments, the side wall has side openings that are flush, e.g., aligned, with the fastening openings. It is proposed that the fastening means may be guided through the side openings. As the fastening means are then guided both through the fastening wall and through the side wall, it can be ensured that particularly large loading forces can be absorbed. The fastening means can be constructed in one piece.

According to at least some embodiments of the proposed longitudinal adjusting device, it is provided that the seat rail is in engagement with the floor rail to form a channel. The spindle may be arranged in the channel. It may be that the fastening means protrude into the channel. Likewise, it may be that the fastening means cross the channel. The expression “cross” means that they can be guided both into the channel and also guided back out through the channel.

The proposed longitudinal adjusting device may be characterized in that the gear has a gear holder with a central part or portion and with side parts or portions flanking the central part for fastening the gear to the seat rail and in that the side parts in each case have a holder opening, through which the fastening means are guided in each case. The holder openings of the side parts may be flush, e.g., aligned, with the fastening openings. The gear holder may be constructed in one piece or multiple parts.

At least some embodiments of the proposed longitudinal adjusting device are characterized in that the seat rail can be displaced along a displacement axis or direction with respect to the floor rail. Here, it may in particular be the case that the central part is arranged substantially along the displacement axis between the side parts. In other words, the side parts are offset with respect to the central part at least also along the displacement axis and then in the opposite direction in each case. The central part may have a central part wall that is substantially parallel to the fastening wall.

At least some embodiments of the proposed longitudinal adjusting device are characterized in that the side parts in each case have an angled wall with the holder opening and a transition wall arranged at an angle to the angled wall. The angled walls may be in each case connected to the central part by the transition wall. In at least some embodiments, the side parts have spindle openings, through which spindle openings the spindle is guided. The transition walls may have the spindle openings.

According to at least some embodiments of the proposed longitudinal adjusting device, it is provided that the holder openings are arranged offset with respect to the spindle openings along a vertical axis orientated perpendicular to the vehicle floor. In this manner, it is possible to prevent the fastening means from coming into engagement with the spindle. Furthermore, it may be that the holder openings are arranged offset with respect to the spindle openings in a non-overlapping manner along the vertical axis. Offset in a non-overlapping manner means that in the case of a respective projection of the spindle openings and the holder openings in a respective normal direction of the opening surface, these projections do not touch.

According to a further possible embodiments of the proposed longitudinal adjusting device, it is provided that the fastening wall is arranged at an angle with respect to the vehicle floor. The fastening wall may be arranged substantially at right angles to the base wall. Accordingly, it is contemplated that the fastening wall may be arranged substantially at right angles to the vehicle floor.

At least some embodiments of the proposed longitudinal adjusting device are characterized in that the floor rail has first catch apertures for accommodating first catch arms. Locking of the seat rail with respect to the floor rail can be achieved by means of these first catch apertures. In at least some such embodiments, the first catch apertures are offset along the displacement axis with respect to one another. In at least some embodiments, the floor rail has second catch apertures for accommodating second catch arms, which second catch apertures are arranged offset with respect to the first catch apertures in the direction of the fastening wall. Due to the provision of additional second catch apertures, the possibility of locking can be improved.

At least some embodiments of the proposed longitudinal adjusting device are characterized in that the longitudinal adjusting device has a shaft for driving the spindle nut and in that the gear has a receptacle for the shaft, which receptacle is set up to transmit a rotational movement of the shaft to the spindle nut. In principle, the transmission of the rotational movement of the shaft to the spindle nut can take place in any desired manner. The receptacle may be coupled to a worm of the gear, which worm is in engagement with the spindle nut. In particular, the worm may be in engagement with external toothing of the spindle nut.

According to at least some embodiments of the longitudinal adjusting device, it is provided that the gear has a gear housing, in which gear housing the receptacle and the spindle nut are arranged. In at least some embodiments, the worm is also arranged in the gear housing. In particular, it may be that the gear housing is surrounded by the gear holder.

According to a further possible embodiments of the longitudinal adjusting device, it is provided that the gear housing has a larger extent in the direction of the vertical axis than in the direction of the displacement axis.

At least some embodiments of the longitudinal adjusting device are characterized in that the gear has rubber mountings, between which the gear housing is enclosed. The rubber mountings may be arranged between the gear holder and the gear housing. In particular, it may be that the rubber mountings are arranged offset with respect to one another along the displacement axis.

At least some embodiments of the longitudinal adjusting device are characterized in that the fastening wall has a shaft opening, through which the shaft is guided. The shaft opening may be arranged along the displacement axis between the fastening openings in particular. It may specifically be that the shaft opening is arranged along the vertical axis at the height of the fastening openings.

According to at least some embodiments of the longitudinal adjusting device, it is provided that the seat rail has an upper wall, which is arranged substantially parallel to the base wall. The upper wall may be arranged at an angle and in in at least some embodiments at right angles to the fastening wall. Likewise, it may be that the upper wall connects the fastening wall to the side wall.

Other details, features, objectives and advantages are explained in the following description with reference to the Figures, which are understood not to be limiting.

### BRIEF DESCRIPTION OF THE DRAWINGS

FIG. 1 is an exploded view of a longitudinal adjusting device, and

FIG. 2 is a perspective sectional view of the longitudinal adjusting device of FIG. 1.

### DETAILED DESCRIPTION

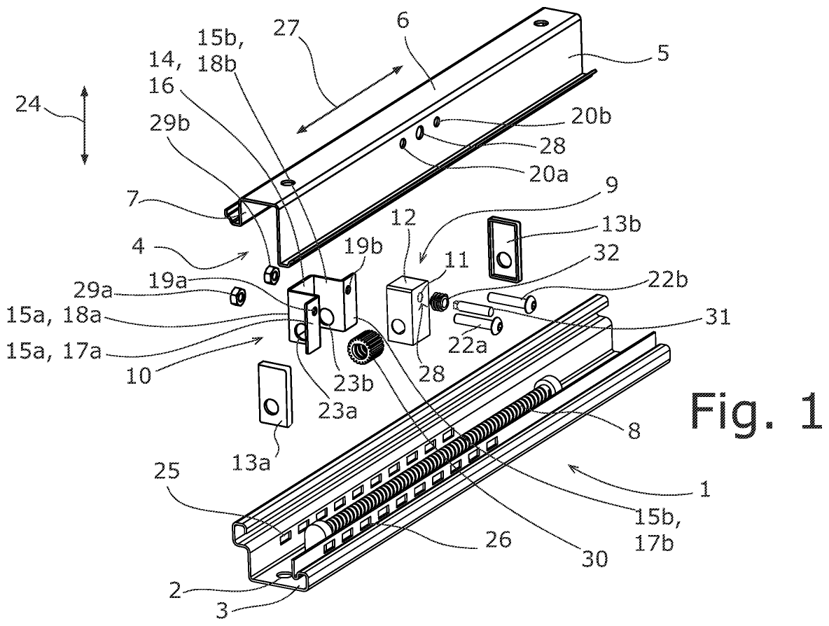

The longitudinal adjusting device shown in FIG. 1 is used for the longitudinal adjustment of a vehicle seat, which is not shown here. The longitudinal adjusting device has a floor rail 1, which can be fastened through its openings 2 on the base wall 3 to the vehicle floor—which is not shown here. In the case of such fastening, the vehicle floor is aligned parallel to the base wall 3. The floor rail further has first catch apertures 25 and second catch apertures 26, which are used for locking during manual longitudinal adjustment after reaching the desired position. The catch arms, which then engage into the first catch apertures 25 and into the second catch apertures 26, are not shown here.

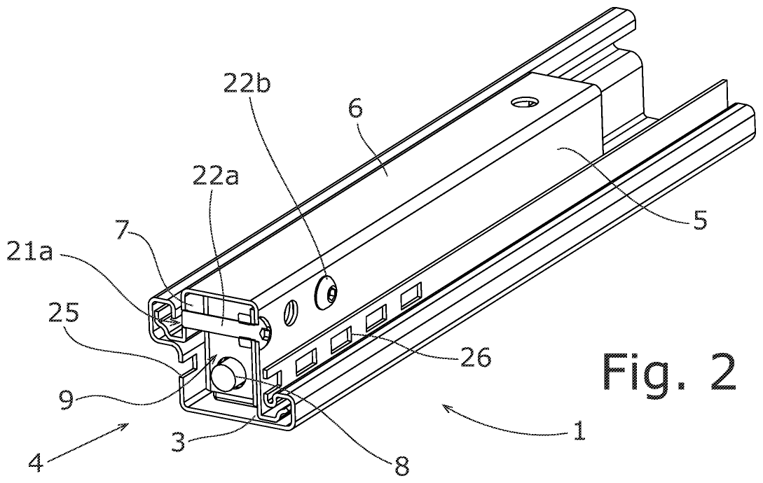

Likewise, the longitudinal adjusting device has a seat rail 4 with a fastening wall 5, an upper wall 6 and a side wall 7. The seat rail 4 is—as illustrated in FIG. 2—in engagement with the floor rail 1 in such a manner that it can be displaced with respect to the floor rail 1 along a displacement axis 27. The fastening wall 5 is perpendicular to the base wall 3 and thus also to the vehicle floor.

The floor rail 1 and the seat rail 4, form by means of their engagement a channel, in which a spindle 8 that is rigidly coupled to the floor rail 1 is arranged. A gear 9 is in turn rigidly coupled to the seat rail 4, which gear consists of a gear holder 10, a receptacle 11 for a shaft 31, a gear housing 12, rubber mountings 13a, b and a spindle nut 30, which is in engagement with the spindle 8, and a worm 32. The receptacle 11 can be driven by the shaft 31, which is in engagement with it, as a result of which the worm 32 and in turn by this the spindle nut 30, the external toothing of which is in engagement with the worm 32, is driven. The worm 32 and the spindle nut 30 are arranged in the gear housing 12.

The rotation of the spindle nut 30 effects a displacement of the gear 9 and thus of the seat rail 4 in the direction of the displacement axis or direction 27. The fastening wall 5 has a shaft opening 28, which is flush with the receptacle 11.

The gear holder consists of a central part or portion 14 having a central part wall 16 and from side parts 15a, b, which side parts 15a, b in each case have an angled wall 17a, b and a transition wall 18a, b. The angled walls 17a, b in each case have a holder opening 19a, b, which is in turn in each case flush with fastening openings 20a, b in the fastening wall 5. Likewise, the holder openings 19a, b are in each case flush with side openings 21a, b in the side wall 7. Fastening means 22a, b, which are constructed as screws here, are in each case guided through the fastening openings 20a, b, the holder openings 19a, b and the side openings 21a, b, and thus both cross the channel. Crash loads on the vehicle seat can then be absorbed both by the fastening wall 5 and by the side wall 7. The screws are in engagement with a respective screw nut 29a, b.

The transition walls 18a, b in each case have a spindle opening 23a, b, through which the spindle 8 is guided. Due to the offset of the spindle openings 23a, b with respect to the holder openings 19a, b along the vertical axis 24, which is orientated vertically to the vehicle floor and to the base wall 3, there is no engagement or contact between the spindle 8 and the fasteners 22a, b.

As should be understood to those of ordinary skill in the art, this description is not intended to disclose all possible embodiments of the invention and combinations of features thereof, and this description should not be interpreted to apply only to the specific exemplary apparatuses described herein or the exemplary methods described herein, or exemplary combination of features. That is, the inventors expressly contemplate that the invention includes any combination or sub-combination of features described herein, regardless of whether such are explicitly described or shown herein.

As may be recognized by those of ordinary skill in the pertinent art based on the teachings herein, numerous changes and modifications may be made to the above-described and other embodiments of the present disclosure without departing from the spirit of the invention as defined in the claims. Accordingly, this detailed description of embodiments is to be taken in an illustrative, as opposed to a limiting sense.

What is claimed is:

1. A longitudinal adjusting device for a vehicle seat comprising:
a floor rail configured to be fastened to a vehicle floor, the floor rail defining a base wall configured to contact a vehicle floor;
a spindle rigidly coupled to the floor rail;
a seat rail displaceable relative to the floor rail and including a fastening wall oriented at an angle to the base wall and including fastening openings, and a side wall substantially parallel to the fastening wall and including side openings aligned with the fastening openings;
a gear including a spindle nut in engagement with the spindle and a gear holder defining a central portion and side portions flanking the central portion and defining holder openings;
wherein the gear is axially rigidly coupled to the seat rail by fasteners, each fastener extending through a respective fastening opening, holder opening and side opening.

2. The longitudinal adjusting device according to claim 1, wherein the seat rail is in engagement with the floor rail to define a channel therebetween.

3. The longitudinal adjusting device according to claim 1, wherein the holder openings are aligned with the fastening openings.

4. The longitudinal adjusting device according to claim 1, wherein the seat rail is displaceable relative to the floor rail in a displacement direction.

5. The longitudinal adjusting device according to one of claim 1, wherein the side portions each define an angled wall including at least one of the holder openings and a transition wall oriented at an angle to the angled wall.

6. The longitudinal adjusting device according to claim 5, wherein the side portions define spindle openings through which the spindle extends and the holder openings are vertically offset from the spindle openings.

7. The longitudinal adjusting device according to claim 1, wherein the fastening wall is configured to be oriented at an angle relative to a vehicle floor when the base wall is in contact with a vehicle floor.

8. The longitudinal adjusting device according to claim 1, wherein the fastening wall is oriented substantially perpendicular to the base wall and/or configured to be oriented substantially perpendicular to a vehicle floor.

9. The longitudinal adjusting device according to claim 7, wherein the floor rail defines first catch apertures configured to receive therein first catch arms.

10. The longitudinal adjusting device according to claim 9, wherein the floor rail defines second catch apertures configured to receive therein second catch arms, wherein the second catch apertures are offset from the first catch apertures on an opposite side of the fastening wall from the first catch apertures.

11. The longitudinal adjusting device according to claim 9, further including a shaft configured to drive the spindle nut, wherein the gear defines a receptacle configured to engage the shaft and transmit a rotational movement of the shaft to the spindle nut.

12. The longitudinal adjusting device according to claim 11, configured so that rotational movement of the spindle nut displaces the gear relative to the spindle that, in turn, displaces the seat rail relative to the floor rail.

13. The longitudinal adjusting device according to claim 11, wherein the gear includes a worm in engagement with the spindle nut, and the receptacle is coupled to the worm.

14. The longitudinal adjusting device according to claim 13, wherein the gear includes a gear housing that houses the receptacle, the spindle nut and the worm.

15. The longitudinal adjusting device according to claim 14, wherein the gear housing is at least partially surrounded by the gear holder.

16. The longitudinal adjusting device according to claim 14, wherein a dimension of the gear housing in a vertical direction is larger than a dimension of the gear housing in the displacement direction.

17. The longitudinal adjusting device according to claim 14, wherein the gear further includes rubber mounts between which the gear housing is located.

18. The longitudinal adjusting device according to claim 17, wherein the rubber mounts are located between the gear holder and the gear housing.

19. The longitudinal adjusting device according to claim 17, wherein the rubber mounts are offset from each other in the displacement direction.

20. The adjusting device according to claim 11, wherein the fastening wall defines a shaft opening through which the shaft extends.
